(19) United States
(12) Patent Application Publication
(10) Pub. No.: US 2016/0109015 A1
(43) Pub. Date: Apr. 21, 2016

(54) WORM SHAFT

(71) Applicant: EJOT GMBH & CO. KG, Bad Berleburg (DE)

(72) Inventors: Andreas KIND, Tambach-Dietharz (DE); Wilfried PINZL, Tambach-Dietharz (DE)

(21) Appl. No.: 14/894,020

(22) PCT Filed: May 27, 2014
(86) PCT No.: PCT/EP2014/060996

§ 371 Date: Nov. 25, 2015

(30) Foreign Application Priority Data
May 28, 2013 (DE) 10 2013 105 478.1

(51) Int. Cl. F16H 55/22

(52) U.S. Cl. CPC F16H 55/22

(57) ABSTRACT

The invention relates to a worm shaft (10) comprising a first component (12) which bears a screw flight (14) and which has a first worm shaft end, and a second component (18) which has a second worm shaft end, wherein the axial extension (A) of the worm shaft (10) is defined by the spacing of the first worm shaft end from the second worm shaft end, wherein the axial extension (A) is fixed by connecting the first and second components (12, 18) at a predefined spacing by means of a connection member. The invention is characterized in that the axial extension (A) of the worm shaft (10) is set by the axial extension (A) of the connection member.

The present relation relates to a worm shaft as defined in the preamble of claim 1, and to a process for its manufacture, as defined in claim 7.

Disclosed in US 2007/0295134 A1 is a worm shaft for driving a mirror adjustment device. This worm shaft includes a shank having first and second ends, said shank being adapted to receive a first component supporting a screw flight, which first component is slid onto the shank via its first end and is non-rotatably locked thereon by means of a splint. Said worm shaft furthermore has a second end, with the first and the second component being connected to each other and spaced from each other by a predefined distance through a connection member.

EP 1 264 735 A1 also discloses a mirror adjustment device which uses a worm shaft for driving the mirror, which worm shaft comprises a spur gear and a section including a screw flight, said shaft being mounted on the mirror frame via its two end points.

DE 10 2004 058 152 B3 discloses a worm shaft having a first component including a screw flight, and a second end of the worm shaft. The component including the screw flight has a constriction which serves as a fixing area for locking the second end of the worm gear in place by means of a bracket. This worm shaft is preferably produced in two parts, with a clamping area being used to axially lock two components in place relative to each other. Moreover, another design is conceivable in which the worm shaft is fixed in position relative to the housing by means of a splint clip.

DE 197 25 414 A1 discloses a one-piece worm shaft having a first and a second end. The worm shaft is driven by a motor drive shaft and is provided with a dog.

DE 10 2012 010 869 A1 discloses a worm shaft having a first adapter end which is in turn connected to an adapter element of a motor shaft via a connecting element.

U.S. Pat. No. 6,912,927 B2 discloses a worm shaft consisting of plural parts, in particular two parts, which can be put together from several worm shaft parts in the manner of an assembly kit.

The shortcoming of the aforementioned systems is that their axial extension is especially designed for certain types of drives.

In order to adapt these systems to any specific components, the prior art documents specify that special parts need to be produced for any such embodiment. The sum of the axial extension of such special parts will then correspond to the axial distance of the ends.

It is the object of the present invention to provide a worm shaft which can easily be adapted to various axial extensions, without the necessity to produce different threaded parts for this purpose.

This object is accomplished by the present invention in that the worm shaft comprises a first component which bears a first screw flight and which has a first worm shaft end, and a second component which is spaced therefrom, In accordance with the invention, these components are connected by means of a connection member, with the axial extension of the connection member at the same time determining the axial extension of the worm shaft. The connection member is formed in one piece, connecting the first component to the second component in that it at least partially surrounds said first and second components. The single-part design of the connection member which at least partially surrounds the first and second components allows its axial extension to be adapted in a simple, flexible and continuously variable way based on standardized parts.

The connection member preferably positively connects the first and second components both in an axial direction and in the direction of rotation. However, such positive fit may also be obtained in one direction only. A corresponding positive fit may be generated in the surrounded area, by providing a suitable profiling or undercut in the surrounded area.

A one-piece surrounding connection member may preferably be obtained in that first and second components of a standard size are at least partially surrounded through the connection of these components at a certain distance from each other by a connection element, said connection element having been formed about the first and second component through primary shaping. Specifically, said primary shaped part may be a casting or an injection-moulding. Use of primary shaping allows the axial extension of the worm shaft to be continuously varied for connecting the two components, without the necessity to change the first and second components of the worm shaft in any way. Standardized worm shaft components may thus be readily adapted to different bearing distances.

In yet another advantageous embodiment, said first and second components may be specifically produced in a cold forming, machining, forging, sintering or die-casting process.

In another embodiment of the invention, the connector may be formed as a drive device, specifically in the form of a gear, for example in the form of this worm gear. This allows the worm shaft to be supported at either end, with the gear acting to transmit a rotary motion of the screw flight.

This allows the second component to be designed in a particularly simple way, especially regarding its use in an electric mirror adjustment device, by also producing the worm gear, which is manufactured by a casting or injection moulding process, at the time when the first and second components are being connected. The production of the worm gear and the connection of the two components of the worm shaft can thus be implemented in a single working step.

In yet another advantageous embodiment, the first or second component may have a pin/bore geometry or a profile geometry at its ends which face each other. A pin and bore geometry ensures increased strength of the worm shaft after connection of the two components, since the form fit is improved.

The profile geometry helps achieve an additional form fit which will contribute to the transmission of torque from component to component and/or from connector to component.

The invention furthermore relates to a process for manufacturing a worm shaft of the aforementioned type. For this purpose, a first component which bears a screw flight, and a second component are produced.

The process according to the invention is characterized in that said first and second components are aligned in a desired axial extension, and such axial extension is fixed in position by integrally forming a connection member thereon which at least partially surrounds the two components. A one-piece connection member locks the two components in their desired axial extension. Such locking may preferably be form-fitting in at least one direction.

In a first advantageous embodiment of the invention, the connection member is manufactured through primary shaping, in particular in a casting or an injection moulding process.

Said first and second components may be produced in a machining, cold forming, forging, sintering or die-casting process. In this way, a worm shaft of random extension may be produced in a simple and needs-oriented manner.

Further advantages, features and possible applications of the present invention may be gathered from the description which follows, in which reference is made to the embodiment illustrated in the drawings.

Throughout the description, claims and drawings, those terms and associated reference signs are used as are listed in the list of reference signs below. In the drawings,

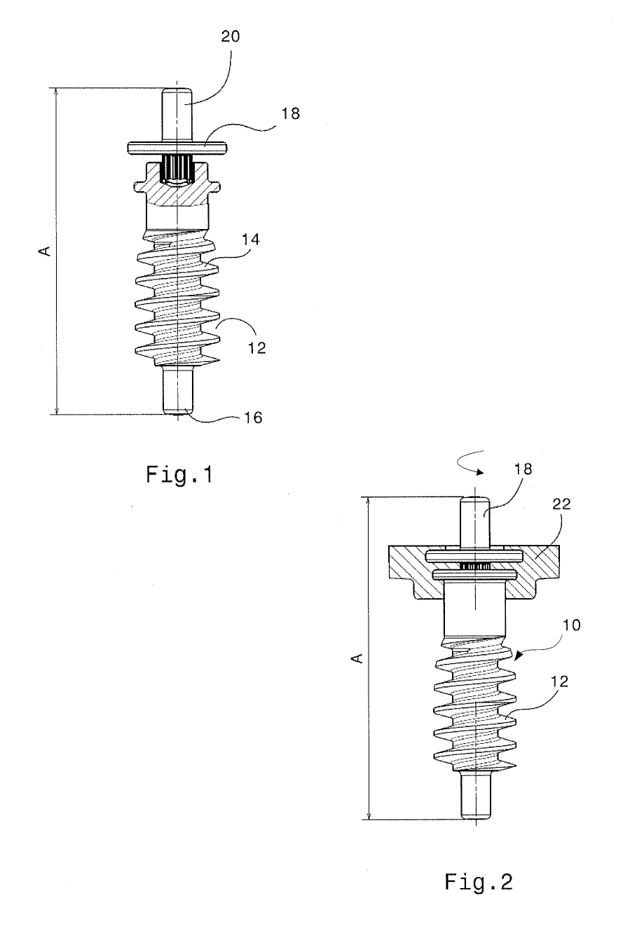

FIG. 1 is a view of first and second components of a worm shaft according to the invention;

FIG. 2 is a view of a worm shaft according to the invention; and

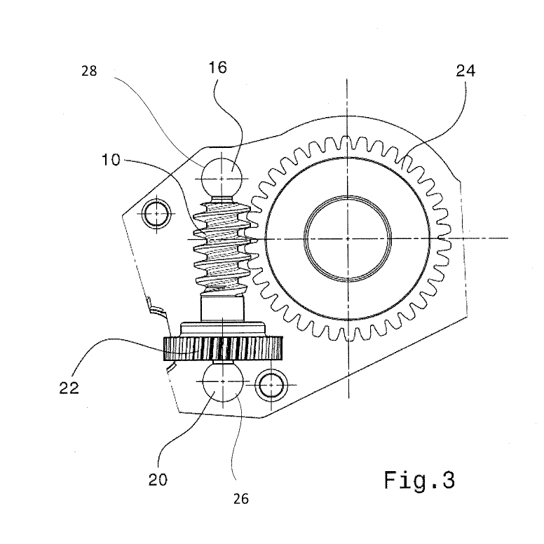

FIG. 3 is a view of a mirror adjustment device.

FIG. 1 is a view of first and second components of a worm shaft according to the invention 10. The first component 12 comprises a screw flight 14. At its first worm shaft end, it features a bearing pin 16. The worm shaft end which faces away from the first component bears the second component 18 which features a second bearing pin 20. Said first and second components 12, 18 are arranged such that they space the ends of said first bearing pin 16 and said second bearing pin 20 in a desired axial worm shaft extension A. As is illustrated in more detail in FIG. 2, said first and second components 12, 18 are thus firmly connected in a relative position to each other which ultimately determines the axial extension A of the worm shaft 10.

In this way, said first component 12 and said second component 18 may be produced for a plurality of different axial extensions A without any adaptation being required, because—as is shown in detail in FIG. 2—the ultimate axial extension A of the worm shaft 10 is defined by the connection member. FIG. 1 furthermore shows that the two ends of the first component 12 and of the second component 18 which face each other have a profiled structure. This allows an improvement of a form fitting which is obtained in a subsequent plastic overmoulding step.

FIG. 2 is a view of a worm shaft 10 according to the invention, in which case the first component 12 and the second component 18 are connected by a connection element which here takes the form of a plastic overmoulding of the two components 12, 18, in order to set the axial extension A of the worm shaft 10. The plastic overmoulding allows continuous adaptation to different axial extensions A. The connection member shown in FIG. 2 is designed in the form of a gear 22. This gear 22, which serves as the connection member, surrounds said first component 12 and said second component 18 at least partially. The first component 12 can thus be manufactured in a simple way, nevertheless ensuring the transmission of torque from the worm shaft 10 to a gear 22.

FIG. 3 is a view of a mirror adjustment device in which a worm shaft 10 according to the invention has been integrally mounted. As shown in FIG. 3, said worm shaft 10 has its first bearing pin 16 and its second bearing pin 20 mounted in round bearing seats 26, 28. This makes for largely friction-free rotation of the worm shaft 10. The position of the worm shaft 10 in the mirror adjustment device has been chosen such that the plastic gear 22 which functions as a connection member can be made to engage an electric motor. The rotary motion transmitted by the plastic gear 22 causes the component 12 bearing the screw flight 14 to rotate, thus enabling it to drive a driven gear (24).

The worm shaft 10 of the invention makes it possible to deal with various mounting situations for which slightly different axial distances are required. This is particularly significant in the production of standardized components, for example a worm drive for a mirror adjustment device, as this usually involves the installation of similar concepts which only differ slightly in their dimensions. The manufacturing process according to the invention allows these minor differences to be taken into account in a simple way using standardized components.

1. Worm shaft comprising a first component which bears a first screw flight and which has a first worm shaft end, and a second component which has a second worm shaft end, with the axial extension of the worm shaft being defined by the spacing of the first worm shaft end from the second worm shaft end, wherein the axial extension is fixed in that the first and second components are connected at a predefined spacing by a connection member, characterized in that the axial extension of the worm shaft is set by the axial extension of the connection member, which connection member is formed in one piece and surrounds said first component and said second component at least partially.

2. Worm shaft as claimed in claim 1 characterized in that the connection member is a part formed through primary shaping, in particular a casting or an injection moulding.

3. Worm shaft as claimed in claim 1 characterized in that the external form of the connection member is that of a drive means, in particular a gear.

4. Worm shaft as claimed in claim 1 characterized in that the form of the connection member has been chosen such that a drive means, in particular a gear, can be supported therein in an at least torque-proof manner.

5. Worm shaft as claimed in claim 1 characterized in that the outer axial ends of said first component and said second component have a bearing element thereon, and the ends of said components which face each other comprise a profile geometry.

6. Worm shaft as claimed in claim 1 characterized in that said first and second components are components produced in a cold forming, machining, forging, sintering or die-casting process.

7. Process for manufacturing a worm shaft as claimed in claim 1, wherein a first component which bears a screw flight and which has a first screw shaft end is connected to a second component which has a second warm shaft end characterized in that said first and second components are arranged in true alignment in the desired axial extension and that such axial extension is fixed in position by integrally forming a one-piece connection member thereon.

8. The process as claimed in claim 7 characterized in that the connection member is produced by primary shaping.

9. The process as claimed in claim 8 characterized in that the connection member is produced in a casting or injection moulding process.
